(19) United States
(12) Patent Application Publication
(10) Pub. No.: US 2014/0346713 A1
(43) Pub. Date: Nov. 27, 2014

(54) METHOD AND DEVICE FOR FORMING FINE PATTERNS

(71) Applicant: Panasonic Corporation, Osaka (JP)

(72) Inventor: Tosihiko WADA, Osaka (JP)

(73) Assignee: Panasonic Corporation, Osaka (JP)

(21) Appl. No.: 14/281,943

(22) Filed: May 20, 2014

(30) Foreign Application Priority Data
May 24, 2013 (JP) 2013-109776

(51) Int. Cl. B29C 59/16

(52) U.S. Cl. CPC B29C 59/16
USPC 264/496; 425/174.4

(57) ABSTRACT

A method for forming fine patterns, including: holding, by a holding member, a sheet-like deformable thin-plate mold with fine patterns having been predeterminedly formed, above a UV-light-transparent substrate such that a UV hardening resin has been applied beforehand on a surface thereof, in such a manner that the mold is at a predetermined angle inclined with tension being applied; and letting a surface of the thin-plate mold serially get in contact with the UV hardening resin by allowing, after a first pressing roll installed above the thin-plate, mold is allowed to descend from above the thin-plate mold, the first pressing roll to relatively move concerning the substrate in a lateral direction while pressing, by the first pressing roll, the thin-plate mold against the UV hardening resin with a predetermined pressure.

### BACKGROUND OF THE INVENTION

1. Field of the Invention

The present invention relates to a method and a device for forming fine patterns using a nano-imprint technology.

2. Related Art of the Invention

In recent years, it has been desired to realize, in optical components that are used for a product for display, illumination and the like, a device exerting a new function of controlling the reflection and diffraction of light, by forming fine patterns of nanometer (nm) order or micrometer (μm) order that demonstrate special optical characteristics.

As a method for manufacturing optical components that have fine shapes, a nano-imprint technology is used. The nano-imprint technology is a method of shaping fine shapes with transcription to the resin surface, by using a die with the fine shapes, which have been designed and processed beforehand on the surface, and pushing the die against the resin that has been applied to the base surface. There are, as methods for transcription, a heat imprint method of carrying out, using a heat-hardening-type resin as the resin to be applied on the substrate surface, transcription with heating at the time of transcription, and a UV imprint method of carrying out transcription by using a UV hardening resin and UV light irradiation at the time of transcription.

For the heat imprint method, selectivity of the material is broad, but the transcription rate with the die is not raised because the viscosity of the material is high, and the throughput is not raised because time is required for allowing the temperature to rise and fall.

On the other hand, for the UV imprint method, there is a problem of selectivity of the material. However, since the material viscosity is generally low, the transcription rate with the die is high and, moreover, since hardening is carried out with ultraviolet light irradiation, the throughput is high.

Whether the heat imprint method is to be adopted or the UV imprint method is to be adopted will depend on the applicable device but, in a case where there is no problem due to the material, it is considered that the UV imprint method is suitable for a mass production method.

FIGS. 7A-7D show schematic drawings of a UV nano-imprint method. After the mold 61 is prepared with predetermined shapes to prepare having been processed (FIG. 7A), the mold 61, which has fine shapes, is pressed against the UV hardening resin 63 that has been applied beforehand onto the substrate 62, and the fine shapes on the mold 61 are allowed to be filled with the UV hardening resin 63 (FIG. 7B). And, after the UV hardening resin 63 is irradiated with the UV light 64 and allowed to harden in such a state that the mold 61 is being pressed (FIG. 7C), the fine shapes are shaped with transcription, by releasing the mold 61 from the substrate 62 (FIG. 7D), on the substrate surface. Generally, since it is necessary to irradiate a UV hardening resin with UV light, used is either the method of fabricating the mold with UV-light-transparent construction materials such as quartz and so forth to carry out UV light irradiation from the mold side, or the method of using, to carry out UV light irradiation from the substrate side, UV-light-transparent construction materials for the substrate.

Generally, as a shaping method, there is a method, as shown in FIGS. 7A-7D, of irradiating the resin, which has been applied on the substrate, with UV light after parallelly pushing the plate-shaped mold thereonto, and releasing the mold upward. However, at the time of shaping with a large square measure, since in addition to the pressing pressure of a several-tons level becoming necessary, there is a possibility that a little air could remain inside at the time of pushing, vacuum shaping with decompression has to be carried out in which the whole of the imprint part is covered with a chamber.

As a relevant reference, Japanese Patent Laid-Open No. 2007-281099 gives a prior art for solving the aforesaid problematic point.

In this method, as is shown in FIG. 8, the cylinder-shaped roller 51 is used, and transcription shaping is carried out while the mold 52, on which fine patterns are formed, is sandwiched on the substrate 54 with the transcription membrane 53 installed between the roller 51 and the mold 52 or, alternatively, transcription shaping is carried out while the roller 51 with fine patterns wound on the surface is pushed against the transcription membrane 53 installed on the substrate 54. The hardening of the UV hardening resin of the transcription membrane 53 is implemented by, with the UV irradiator 55 that is installed behind the roller 51, irradiating with UV light the vicinity of the contact place of the roller 51 and the transcription membrane 53.

By this method, since the mold is in progression pushed against the substrate serially by roll transfer and linearly in the roll width direction, forming can be carried out without air being trapped in the mold and the substrate inside as in the above-described shaping method and, since the contact region of the roller and the transcription membrane becomes linear, the pressing pressure can be allowed to be small.

### SUMMARY OF THE INVENTION

However, in the aforesaid conventional method, the roller 51 does not directly push the mold 52, but directly pushes the surface of the transcription membrane 53 before transcription shaping. Because of this, the transcription shaping on the reverse face of the transcription membrane 53 is not done well, and it has been difficult to realize transcription of high precision.

In view of the aforesaid problems, the present invention furnishes, in a UV-hardening-technique roller nano-imprint using a UV hardening resin, a method and a device for forming fine patterns such that transcription of high precision can be realized.

The 1^{st} aspect of the present invention is a method for forming fine patterns, comprising:

holding, by a holding member, a sheet-like deformable thin-plate mold with fine patterns having been predeterminedly formed, above a UV-light-transparent substrate such that a UV hardening resin has been applied beforehand on a surface thereof, in such a manner that the mold is at a predetermined angle inclined with tension being applied;

letting a surface of the thin-plate mold serially get in contact with the UV hardening resin by allowing, after a first pressing roll installed above the thin-plate mold is allowed to descend from above the thin-plate mold, the first pressing roll to relatively move concerning the substrate in a lateral direction while pressing, by the first pressing roll, the thin-plate mold against the UV hardening resin with a predetermined pressure;

letting the UV hardening resin, which has been applied onto the substrate, harden by irradiating, with UV light from below the substrate, a contact part of the thin-plate mold and the UV hardening resin; and

allowing the thin-plate mold to get released from the substrate.

By the aforesaid configuration, for example, in such a state that a sheet-like thin-plate mold is being fixed at a predetermined angle concerning the substrate, with tension being applied to the holding member (for example, the angle adjusting roll) that is installed in the device (the imprint device) for forming fine patterns, sweeping is carried out in the substrate transfer direction under pressing with the first pressing roll. Then, since a state can be made up such that the thin-plate mold in progression serially gets in contact with the substrate surface, on which the UV hardening resin has been applied, at a predetermined angle, a vacuum is not necessitated even for a nano-imprint with a large square measure and shaping of high quality without a little air remaining becomes able to be carried out even under the atmospheric pressure.

Moreover, as this sheet-like thin-plate mold, for example, a resin mold and a metal mold are considered. However, since the mold is held with tension being applied, if the elastic deformation and plastic deformation of the mold by the tension are taken into consideration, then it is preferable that a mold of metal such as Ni and so forth be used.

Because of this, for example, the UV light irradiation for allowing the UV hardening resin, which has been applied onto the glass substrate, to harden is carried out not from the thin-plate mold side, but from the UV-light-transparent glass substrate reverse face side.

Moreover, by the aforesaid method for forming fine patterns, since the UV light irradiation is carried out from below the substrate, if linear UV light irradiation is able to be carried out, only the linear portion where the first pressing roll is pressurizing the thin-plate mold can be irradiated with the UV light.

Moreover, the 2^{nd} aspect of the present invention is a method for forming fine patterns according to the 1^{st} aspect of the present invention, wherein

the thin-plate mold is being held, by the holding member, above the substrate so as to be at the predetermined angle inclined with the tension being applied, in such a state that one end of the thin-plate mold is connected to a supporting stand that supports the substrate.

Moreover, the 3^{rd} aspect of the present invention is a method for forming fine patterns according to the 1^{st} aspect of the present invention, wherein

when the thin-plate mold is allowed to get released from the substrate, the thin-plate mold is, by allowing the first pressing roll to relatively move in a direction reverse to the lateral direction, allowed to serially get released from the substrate.

By means of this, for example, after sweeping with the first pressing roll has been carried out to the substrate terminal end, sweeping with the first pressing roll can be, in such a state that the UV light irradiation is not carried out, allowed to be carried out in the substrate starting end direction, namely in the reverse direction. By doing like this, because the releasing position of the thin-plate mold at a contact position of the first pressing roll and the substrate surface can be maintained, stable releasing becomes able to be realized.

Namely, the aforesaid 3^{rd} aspect of the present invention takes into consideration that, in a case where a mass production method by the method for forming fine patterns is assumed, the releasing mechanism of the thin-plate mold also becomes an important element. Specifically, in a method for forming fine patterns, not by the aforesaid configuration, but by, for example, at the point in time when the sweeping with the pressing roll has been carried out to the substrate terminal end, canceling the pressurization of the pressing roll and raising the pressing roll up, the thin-plate mold can also be released by an action of the tensioning being applied to the thin-plate mold. However, in the releasing by a method like this, the releasing of the thin-plate mold from the substrate, without position controlling, proceeds immediately on the whole surface of the substrate. Because of this, there is a possibility of generation of a deterioration of the transcription shape precision due to the state variation of releasing and generation, in an extreme case, of a peeling-off of the UV hardening resin from the glass substrate. However, by the aforesaid 3^{rd} aspect of the present invention, this problem can be avoided.

Moreover, the 4^{th} aspect of the present invention is a method for forming fine patterns according to the 1^{st} aspect of the present invention, wherein

when the first pressing roll is allowed to relatively move concerning the substrate, the angle between the thin-plate mold and the surface of the substrate is kept constant by allowing the holding member, which holds the thin-plate mold, to move in a vertical direction in synchronization with movement of the first pressing roll.

By means of this, the angle between the thin-plate mold and the substrate surface becomes able to be kept constant, and stable transcription shaping can be realized.

Further, if a configuration similar to the aforesaid is also enforced when the releasing is carried out, the angle between the thin-plate mold and the substrate surface becomes able to be kept constant, and stable transcription shaping and releasing can be realized.

Moreover, the aforesaid 4^{th} aspect of the present invention has been created in consideration of the following point.

Suppose that, for example, in the transfer of the first pressing roll, the angle between the thin-plate mold being held with tension applied and the substrate surface varies, for the sake of argument, depending on the position of the first pressing roll. Then, the angle between the thin-plate mold and the substrate and the angle of releasing vary within the substrate face. Namely, the angle between the thin-plate mold and the substrate fluctuates. As a result, there is a possibility that the filling behavior of the UV hardening resin to the fine patterns formed on the surface of the thin-plate mold could vary so as to deteriorate the transcription rate. Moreover, if the angle varies at which the thin-plate mold gets released from the substrate, since the releasing force of the thin-plate mold and substrate varies within the substrate surface, then stable releasing cannot be realized, and there is a possibility of generation of transcription deficiency and peeling of the patterns. But, by the 4^{th} aspect of the present invention, these problematic points can be avoided.

Moreover, the 5^{th} aspect of the present invention is a method for forming fine patterns according to the 1^{st} aspect of the present invention, wherein

after a second pressing roll, which has been, above the thin-plate mold, installed on an opposite side of the holding member with reference to a position of the first pressing roll, is allowed to descend in synchronization with descent of the first pressing roll, the thin-plate mold is pressed by the second pressing roll with a predetermined pressure.

Moreover, the 6^{th} aspect of the present invention is a method for forming fine patterns according to the 5^{th} aspect of the present invention, wherein

the UV hardening resin, which is between the first pressing roll and the second pressing roll, is irradiated with the UV light.

By adding, on the opposite side with respect to the transfer direction of the first pressing roll, a second pressing roll that presses the thin-plate mold and carrying out the UV light irradiation between the first pressing roll and the second pressing roll, stable transcription shaping can be realized with uplift of the thin-plate mold from the substrate prevented.

Further, the aforesaid 6^{th} aspect of the present invention has been created in consideration of the following point.

Namely, for the UV light irradiation in a method for forming fine patterns, if able to be irradiated with the UV light is only the linear portion where the first pressing roll is pressurizing the thin-plate mold, then that is indeed ideal. But, the UV light has a width of a constant value, and there is a possibility that irradiation could be carried out ahead of and behind the linear portion where the thin-plate mold is being pressurized. Since the UV light irradiation, which is carried out ahead of the portion that is being pressurized, where the thin-plate mold is not in contact with the UV hardening resin on the substrate, remarkably deteriorates the transcription, it is desirable that the UV light irradiation be carried out at the linear portion that is being pressurized and therebehind. However, if the configuration of the aforesaid 6^{th} aspect of the present invention is not comprised, since behind the portion that is being pressurized, no pressurizing force is being applied, there is a possibility that the transcription could deteriorate with uplift of the thin-plate mold from the substrate. By the aforesaid 6^{th} aspect of the present invention, this problematic point can be avoided.

Of course, this does not mean that the second pressing roll is an indispensable element.

And, the portion that is being pressurized does not always necessitate being irradiated with the UV light, but it is sufficient that the contact part of the thin-plate mold and the UV hardening resin is irradiated with the UV light.

Moreover, the 7^{th} aspect of the present invention is a method for forming fine patterns according to the 1^{st} aspect of the present invention, wherein

when irradiation with the UV light is carried out from below the substrate, the irradiation with the UV light is carried out via a light-shielding mask that is installed below the substrate.

For example, with a light-shielding mask installed between the transparent supporting stand with the glass substrate installed thereon and the glass substrate, only a predetermined position of the ultraviolet light hardening resin applied onto the glass substrate becomes able to be irradiated with the UV light, and the patterning in a method (a nano-imprint method) for forming fine patterns becomes able to be carried out. Further, the resin of the unhardened portion not irradiated with the UV light have only to be removed after the releasing of the thin-plate mold with a predetermined washing liquid.

Moreover, the 8^{th} aspect of the present invention is a method for forming fine patterns according to the 1^{st} aspect of the present invention, wherein

when the substrate is irradiated with the UV light, irradiation is carried out while a UV light source used for the irradiation is allowed to vibrate in a substrate width direction vertical to a relative movement direction of the first pressing roll.

For example, by carrying out the irradiation while allowing the UV light source used for the irradiation to vibrate in the substrate width direction vertical to the roll transfer direction, at a speed that is sufficiently fast compared to the substrate transfer speed, illuminance unevenness in the width direction of the portion that is being pressurized is resolved, and transcription shaping without hardening insufficiency and hardening unevenness can be realized.

Further, the aforesaid 8^{th} aspect of the present invention has been created in consideration of the following point.

Namely, as a light source of the UV light with which the substrate is irradiated, in recent years, a UV-technique LED light source such that numerous LEDs are arranged is often used from the viewpoint of energy saving. However, since an LED light source utilizes superimposed point light sources as a face light source, illuminance unevenness is generated in the width direction of the light source. If brightness unevenness is generated in the UV irradiation in the width direction of the portion that is being pressurized by the first pressing roll, then there is a possibility that hardening insufficiency and hardening unevenness could occur. But, by the aforesaid 8^{th} aspect of the present invention, this problematic point can be avoided.

Moreover, the 9^{th} aspect of the present invention is a method for forming fine patterns according to the 7^{th} aspect of the present invention, wherein

as the UV light source, a light source is used such that a spread angle is collimated so as to be equal to or less than 5 degrees.

By using, as a UV light source used for the UV light with which the substrate is irradiated, a light source such that the spread angle is collimated so as to be equal to or less than 5 degrees, patterning being of high precision can be realized with a practically sufficient light exposure amount.

Further, the aforesaid 9^{th} aspect of the present invention has been created in consideration of the following point.

Namely, in a case where the UV light is not parallel light but has a constant spread angle, since the light, which has passed through the light-shielding mask, spreads according to the distance between the light-shielding mask and the substrate, the substrate thickness, and the resin thickness, there is a possibility that the patterning precision could deteriorate compared to the patterns formed on the light-shielding mask. Because of this, it is desirable that the light from the UV light source be allowed to be parallel light but, generally, in order to allow the light from the LED light source to be parallel light, it is necessary to install a lens on the light source surface. However, in order to obtain complete parallel light, it is necessary to install a comparatively large lens and, if a lens is installed, the packaging density of the LED is not sufficiently raised, so that there is a possibility that the irradiation intensity necessary for the light source could not be obtained. Nevertheless, in a general nano-imprint material, the minimum light exposure amount and patternability being necessary are roughly constant and, since the thickness of the glass substrate used is usually from 0.7 mm to 1.0 mm, it is considered that the spread angle have only to be equal to or less than a constant value.

Moreover, the 10^{th} aspect of the present invention is a method for forming fine patterns according to the 7^{th} aspect of the present invention, wherein

a spacer that has a constant thickness, or a film that has fine protrusions is inserted between the substrate and the light-shielding mask, and between the light-shielding mask and a supporting stand that supports the substrate.

By means of this, transcription unevenness owing to occurrence of Newton rings can be prevented.

Further, the aforesaid 10^{th} aspect of the present invention has been created in consideration of the following point.

Namely, in UV light irradiation of the substrate via the light-shielding mask, in a case where the substrate is installed on the light-shielding mask, occurs a Newton ring due to the interference of light that is generated between the light-shielding mask and the substrate, and between the light-shielding mask and the supporting stand. If the UV light irradiation is carried out in such a state that this Newton ring is being generated, then there is a possibility that the unevenness of this Newton ring could be transcribed into the fine patterns to be formed on the substrate surface. But, by the aforesaid 10^{th} aspect of the present invention, a problem like this can be avoided.

Moreover, the 11^{th} aspect of the present invention is a device for forming fine patterns, comprising:

a UV-light-transparent substrate such that a UV hardening resin has been applied beforehand on a surface thereof;

a supporting stand that supports the substrate;

a sheet-like deformable thin-plate mold with fine patterns having been predeterminedly formed, which is arranged on the substrate;

a first pressing roll, which is arranged above the thin-plate mold and is able to ascend and descend with reference to the substrate; and

a UV light source that is installed below the substrate, wherein

the supporting stand is, along with the thin-plate mold, relatively movable concerning the first pressing roll in a lateral direction, and

when the first pressing roll presses the thin-plate mold, at least one end side of the thin-plate mold is, by the holding member, lifted concerning the UV hardening resin.

Moreover, the 12^{th} aspect of the present invention is a device for forming fine patterns according to the 11^{th} aspect of the present invention, wherein

at a predetermined position on another end side of the thin-plate mold, the thin-plate mold is being pressed against the UV hardening resin by a second pressing roll, and

the UV hardening resin, which is between the first pressing roll and the second pressing roll, is irradiated with UV light from the UV light source.

As above, by a method and a device of the present invention for forming fine patterns, in a UV-hardening-technique roller nano-imprint using a UV hardening resin, transcription of high precision can be realized.

### BRIEF DESCRIPTION OF THE DRAWINGS

FIG. 1 is a schematic diagram of a method and a device in an embodiment of the present invention for forming fine patterns;

FIG. 2 is a schematic diagram of a thin-plate mold in an embodiment of the present invention;

FIG. 3A is a graph of the accumulated light amount in a case where the irradiation has been carried out without vibration of the UV-LED light source in an embodiment of the present invention, and

FIG. 3B is a graph of the accumulated light amount in a case where the irradiation has been carried out with vibration of the UV-LED light source in an embodiment of the present invention;

FIG. 4 is a schematic diagram of a film having fine protrusions in an embodiment of the present invention;

FIGS. 5A-5C are schematic diagrams that describe the action of a device in an embodiment of the present invention for forming fine patterns;

FIG. 6 is a schematic drawing that shows the configuration of a variant example of the device in the embodiment of the present invention for forming fine patterns;

FIGS. 7A-7D are schematic drawings of a conventional UV nano-imprint method; and

FIG. 8 is a schematic diagram of a conventional roll imprint method.

### DESCRIPTION OF SYMBOLS

11 thin-plate mold
12 mold fixing jig
13 angle adjusting roll
14 tension jig
15 first pressing roll
16 second pressing roll
17 UV hardening resin
18 substrate
19 supporting stand
20 first spacer
21 light-shielding mask
22 second spacer
23 UV-LED light source
24 reflection mirror
25 UV light
26 substrate fixing jig
31 fine column shape
32 fine pattern
41 PET base
42 fine protrusion
51 roller
52 mold
53 transcription membrane
54 substrate
55 UV irradiator
61 mold
62 substrate
63 UV hardening resin
64 UV light
113 second angle adjusting roll
114 second tension jig

### PREFERRED EMBODIMENTS OF THE INVENTION

### Embodiment

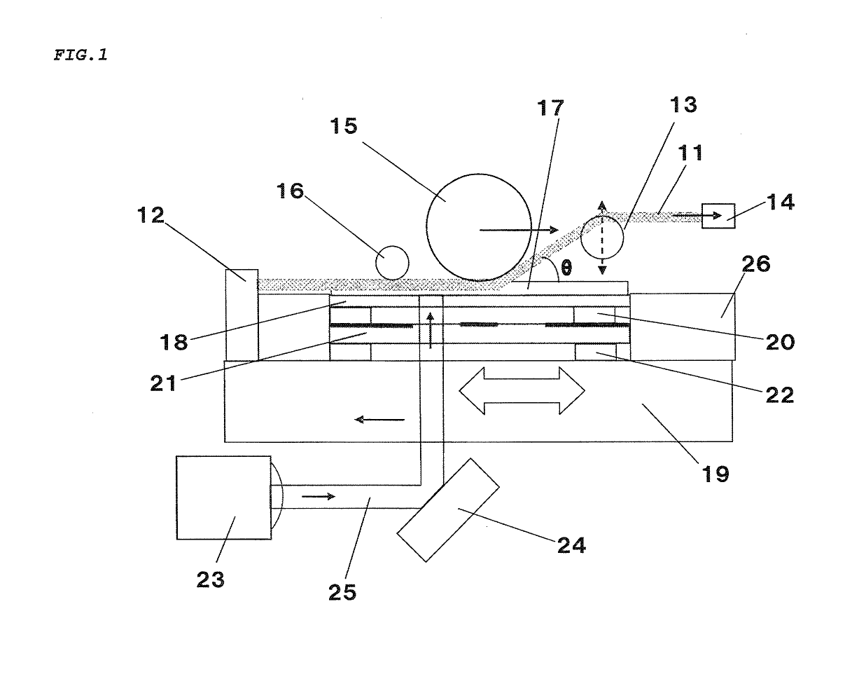

In the following, one embodiment in the present invention is described. FIG. 1 shows a schematic diagram of a method and a device of the present embodiment for forming fine patterns.

As is shown in FIG. 1, the thin-plate mold 11 with fine patterns having been formed thereon is attached to the device for forming fine patterns, where the one end part (the end part on the left side in FIG. 1) is fixed by the mold fixing jig 12, which has been installed on the supporting stand 19, and the other end part (the end part on the right side in FIG. 1) is fixed to the tension jig 14 that is able to, cooperating with the angle adjusting roll 13 movable in the vertical direction, apply tension to the thin-plate mold 11. The angle θ of fixing the thin-plate mold 11 can be adjusted to an arbitrary angle by allowing the position of the angle adjusting roll 13 to vary in the vertical direction.

Further, the angle adjusting roll 13 of the present embodiment is one example of the holding member of the present invention.

Above the thin-plate mold 11, the first pressing roll 15 and the second pressing roll 16 are installed, being attached to the axes (not shown) movable in the vertical direction, and can go down with predetermined pressures respectively.

Moreover, each of the aforesaid axes, which support the first pressing roll 15 and the second pressing roll 16 so that the rolls are movable in the vertical direction, is being fixed to a position without influence of the movement described later of the supporting stand 19.

On the other hand, the axis (not shown), which supports the angle adjusting roll 13 so that the roll is movable in the vertical direction, is being fixed to the supporting stand 19 so as to be movable in a horizontal direction along with the movement described later of the supporting stand 19.

Moreover, the tension jig 14 is being fixed to the supporting stand 19, so as to be movable in the horizontal direction along with the movement described later of the supporting stand 19.

Moreover, the substrate 18 with the UV hardening resin 17 having been applied beforehand on the surface is, sandwiching the first spacer 20, the light-shielding mask 21, and the second spacer 22, being fixed on the supporting stand 19, by the substrate fixing jig 26. And, by the first spacer 20 and the second spacer 22, formed are predetermined spaces between the supporting stand 19 and the light-shielding mask 21, and between the light-shielding mask 21 and the substrate 18.

Moreover, the supporting stand 19 is attached to the axis movable in the horizontal direction independently of the axis for allowing the first pressing roll 15 to move in the vertical direction, and can allow the substrate 18 that has been attached onto the supporting stand 19, the thin-plate mold 11, and so forth to move in the horizontal direction.

Moreover, below the supporting stand 19, the UV-LED light source 23, which is able to carry out irradiation with the collimated UV light 25, is attached so that the light source can carry out the light irradiation in the horizontal direction. And, by the reflection mirror 24 that has been installed below the first pressing roll 15, the UV light 25 with which the irradiation has been carried out by the UV-LED light source 23 is allowed to be reflected in the vertical direction, and the UV light irradiation can be carried out between the first pressing roll 15 and the second pressing roll 16. Moreover, the UV-LED light source 23 is installed on the axis that can move in a direction vertical to the movement direction of the supporting stand 19, and can move in a direction vertical to the UV light irradiation direction.

Namely, the UV-LED light source 23, and the reflection mirror 24 are being fixed to positions without influence of the movement of the supporting stand 19.

By the device as aforesaid for forming fine patterns, transcription shaping of fine patterns has been implemented as follows.

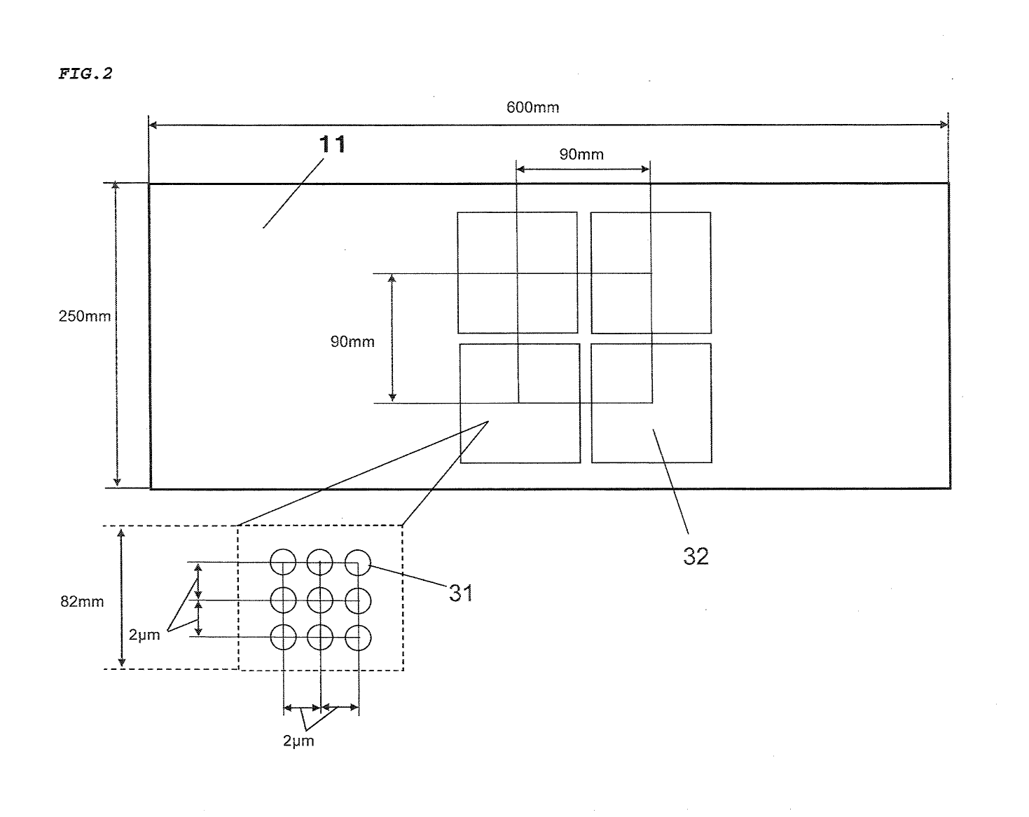

As is shown in FIG. 2, the fine pattern 32 is a pattern 82 mm square, such that the fine column shapes 31 have been formed on the mold surface with a pitch of 2 μm, and a height of 1 μm. As the thin-plate mold 11, a deformable Ni mold with a width of 250 mm, a length of 600 mm, and a thickness of 150 μm has been used, such that 4 faces of the fine pattern 32 have been formed with a pitch space of 90 mm in the mold length and width directions. And, by adjusting the angle adjusting roll and tension jig, the thin-plate mold 11 has been fixed, being inclined so that the angle θ (see FIG. 1) becomes 15°, to the device with a tension of 40 kgf applied.

Moreover, as the light-shielding mask 21, a glass substrate with a thickness of 0.7 mm has been used, such that a Cr membrane has been spattered so that the mask is to be transparent to UV light in 4 faces of the surface portion 80 mm square, with a pitch space of 90 mm in the substrate length and width directions, similarly to the fine pattern that has been formed on the Ni mold.

Shown in FIG. 1, between the supporting stand 19 and the light-shielding mask 21, and between the light-shielding mask 21 and the substrate 18, the first spacer 20 and the second spacer 22 with a thickness of 0.5 mm have been used which hold the substrate outer periphery part with a width of 10 mm.

Moreover, as the UV-LED light source 23, a line light source with an output of 30 mW, and a width of 300 mm has been used such that the spread angle of the UV light with which the irradiation is carried out is collimated to be 5°.

The UV-LED light source 23 having been used for the present embodiment is such that the LEDs have been arrayed with a space of a pitch of 30 mm and, owing to their superimposition the illuminance unevenness is generated.

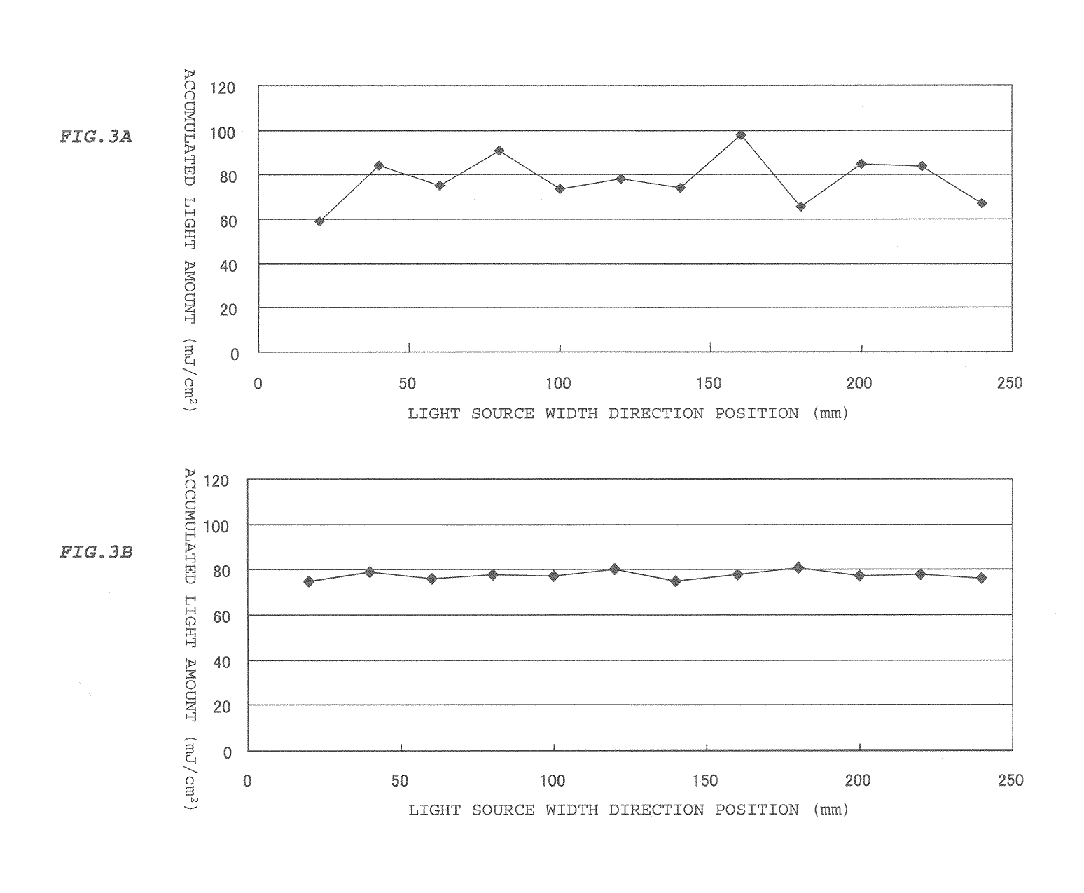

FIG. 3A shows a result of the accumulated light amount in the light source width direction, at the time of moving the supporting stand at 10 mm/sec while carrying out the irradiation with the UV-LED light source 23 at the intensity of 30 mW/cm². Owing to the unevenness due to the pitch space, and the brightness unevenness of an LED singleton, a variation in the accumulated light amount approximately of 25% is generated. However, for the accumulated light amount in a case where the irradiation has been carried out under the same condition while allowing the UV-LED light source 23 to vibrate with an amplitude of 15 mm, and at 1 Hz, the variation has been, as is shown in FIG. 3B, successfully decreased so as to be equal to or less than 5%.

As is shown in FIG. 1, as the substrate 18, a glass substrate with a width of 210 mm, a length of 300 mm, and a thickness of 0.7 mm has been used. First, the UV hardening resin 17 has been applied onto the substrate 18 by spin coating with a thickness of 5 μm, and the substrate 18 with the UV hardening resin 17 having been applied thereon, the light-shielding mask 21, the first spacer 20, and the second spacer 22 have been fixed onto the supporting stand 19. The device of the present embodiment for forming fine patterns is configured so that, at this time, a space of 1 mm is made between the thin-plate mold 11 and the substrate 18.

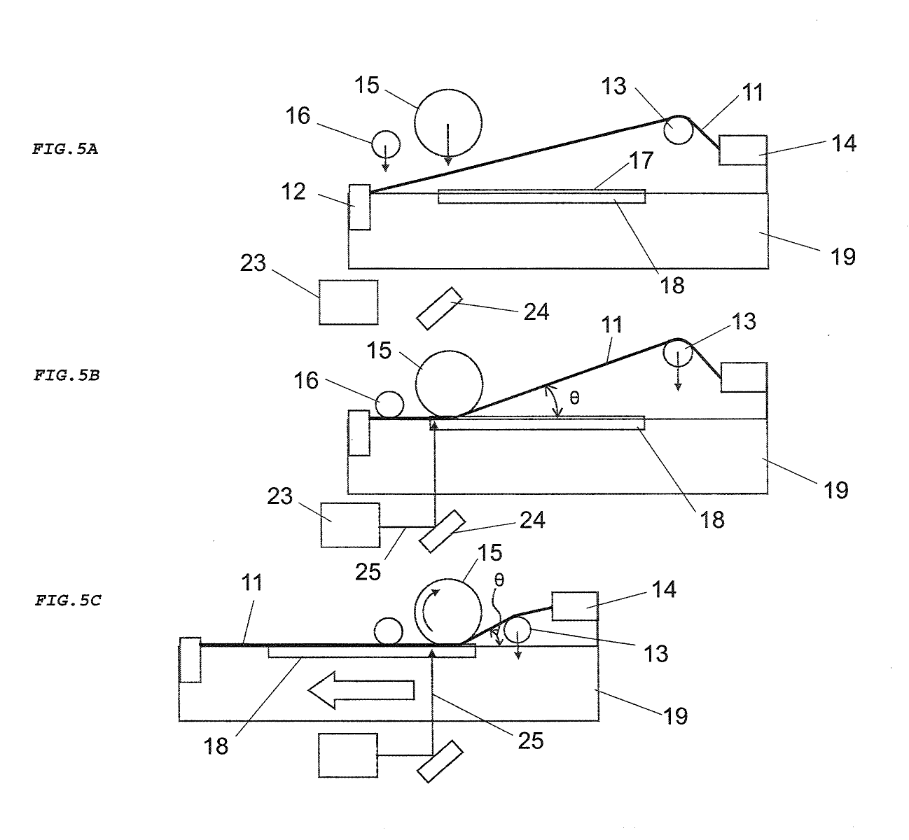

Next, referring to FIGS. 1 and 5A-5C, descriptions are given regarding the action of the device of the present embodiment for forming fine patterns and, at the same time, one embodiment of the method of the present invention for forming fine patterns is also mentioned.

FIGS. 5A-5C are schematic diagrams that describe the action of the device for forming fine patterns.

In such a state that the substrate 18 and the thin-plate mold 11 are being fixed to the device for forming fine patterns, the positions of the first pressing roll 15 and the second pressing roll 16, which is installed at a position of 30 mm behind the first pressing roll 15, have been, allowing the supporting stand 19 to move in the horizontal direction, determined so that the rolls are positioned above the substrate starting end part (see FIG. 5A). After that, with the first pressing roll 15 being allowed to go down with a pressure of 100N and the second pressing roll 16 with a pressure of 50N (see FIG. 5A), first, the thin-plate mold 11 has been allowed to get in contact with the substrate 18 (see FIG. 5B).

Next, in such a state that the pressures of the first pressing roll 15 and second pressing roll 16 are being maintained, while allowing the UV-LED light source 23 to vibrate, the UV light irradiation of 30 mW has been started. And, while carrying out the irradiation with the UV light 25 between the first pressing roll 15 and the second pressing roll 16, the supporting stand 19 has been allowed to move at a speed of the speed 10 mm/sec. At the same time, lowering the position of the angle adjusting roll 13 below, with the angle θ roughly of 15° being kept concerning the substrate 18, the thin-plate mold 11 has been allowed to serially get in contact with the substrate 18 (see FIG. 1). In addition, while irradiating with the UV light 25 only a position where the light-shielding mask 21 is being transparent to the UV light 25, sweeping with the first pressing roll 15 and second pressing roll 16 has been carried out to the substrate terminal end part (see FIG. 5C). Afterward, switching the UV irradiator 55 off and, at a speed of 50 mm/sec, carrying out sweeping with the first pressing roll 15 and second pressing roll 16 to the substrate starting end part in the reverse direction, while keeping the angle of 15° between the thin-plate mold and the substrate, to release the thin-plate mold 11 from the substrate 18, fine patterns have been shaped with transcription on the surface of the substrate 18.

It has been found out that the measurements of the patterns that have been formed in this way are of very high precision approximately of 80+0.03 mm, which is roughly equivalent to the precision of the patterns formed in the light-shielding mask 21.

The precision of the patterning in a nano-imprint method using the light-shielding mask 21 is largely influenced by the accumulated light amount, which depends on the spread angle of the UV light and the transfer speed of the supporting stand 19.

On the substrate, patterns of a precision approximately of 83±1 mm, which are larger than the predetermined shapes, have been formed in a case where transcription shaping has been carried out with a light source with a spread angle of 60° used as the UV-LED light source 23, and the transfer speed of the supporting stand 19 allowed to be 5 mm/sec.

From the above, it has turned out that, by the present embodiment, patterning that is of a very good precision can be realized.

Moreover, as in the present embodiment, by allowing the thin-plate mold 11 to be so thin with a thickness of 150 μm, the tension of fixing without flexure the thin-plate mold 11 on the device becomes able to be made small. As a result, since the pressure of pushing the thin-plate mold 11 against the substrate 18 becomes able to be decreased, with the flexure of the substrate 18 and the light-shielding mask 21, at the time of pressing the first pressing roll 15, becoming small, occurrence of Newton rings between the substrate 18 and the light-shielding mask 21, and between the light-shielding mask 21 and the supporting stand 19 has been successfully suppressed.

Moreover, in a case where there are limitations on thickness of the thin-plate mold 11 that can be fabricated and a constant thickness is necessary, or in a case where a very thin substrate is used as the substrate 18, pressurizing force of the first pressing roll 15 equal to or more than a constant value becomes necessary, or the flexure of the substrate 18 becomes large. Because of this, it is assumed that occurrence of Newton rings cannot be suppressed.

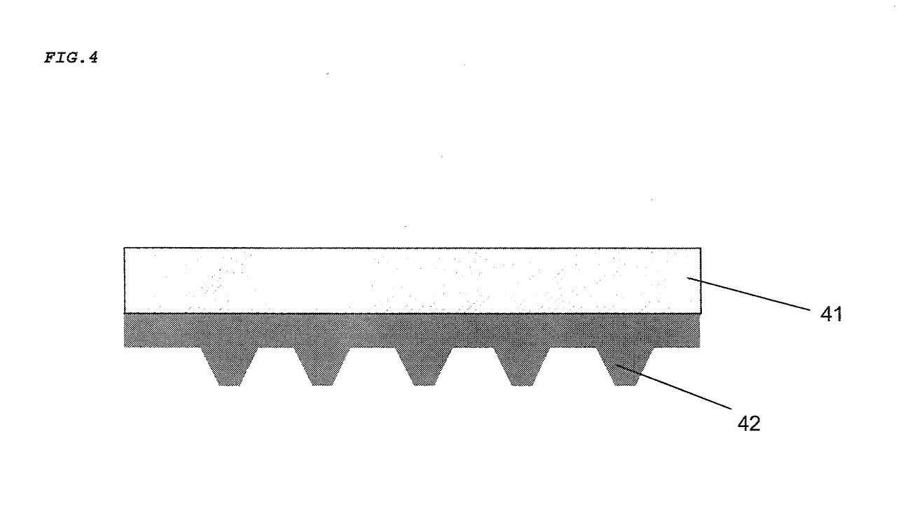

As one example, in a case where the substrate 18 used is so thin as to be 0.5 mm in thickness, Newton rings occur at the time of pressing between the substrate 18 and the light-shielding mask 21 after all. However, in a case like this, instead of the first spacer 20 and the second spacer 22, as is shown in FIG. 4, inserted is a film that has fine protrusions 42 with a height of 5 μm, which have been arrayed in a regular-square lattice-like form with a pitch of 100 μm on the PET base 41 with a thickness of 100 μm, where the protrusion is such that the tip part has been cut from a cone with an elevation angle of 60° so that a flat part of φ0.5 μm is formed. Then, the space between the substrate 18 and the light-shielding mask 21, and the space between the light-shielding mask 21 and the supporting stand 19 become able to be kept equal to or more than 5 μm. As a result, transcription shaping with occurrence of Newton rings suppressed has been successfully realized similarly.

As is clear from what has been described above, by a method and a device of the aforesaid embodiment for forming fine patterns, in a UV-hardening-technique roller nano-imprint using a UV hardening resin, transcription of high precision and high productivity, and high-precision patterning can be realized.

Further, in the aforesaid embodiment, the fixing position of the axis (not shown), which supports the angle adjusting roll 13 so that the roll is movable in the vertical direction, has been fixed to the supporting stand 19 so as to be movable in the right and left direction along with the movement of the supporting stand 19. However, a fixing position like that may be, for example, a position such that the distance in the horizontal direction with regard to the first pressing roll 15 can be, without influence of the movement of the supporting stand 19, held constant. In this case, the configuration, which enables the movement of the angle adjusting roll 13 in the vertical direction, is not necessitated in order to keep constant the angle θ between the thin-plate mold 11 and the UV hardening resin 17 on the substrate 18, but becomes necessary in order to make θ change so as to be an arbitrary angle.

Moreover, in the aforesaid embodiment, the supporting stand 19 has been, concerning the first pressing roll 15 and the second pressing roll 16, allowed to move in the horizontal direction. However, for example, the first pressing roll 15 and the second pressing roll 16 may be, with the supporting stand 19 fixed, allowed to move in the horizontal direction.

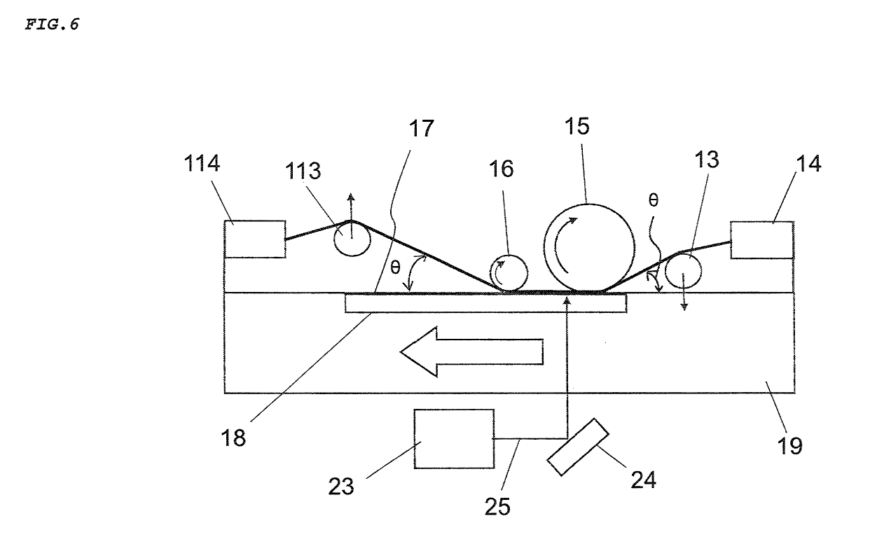

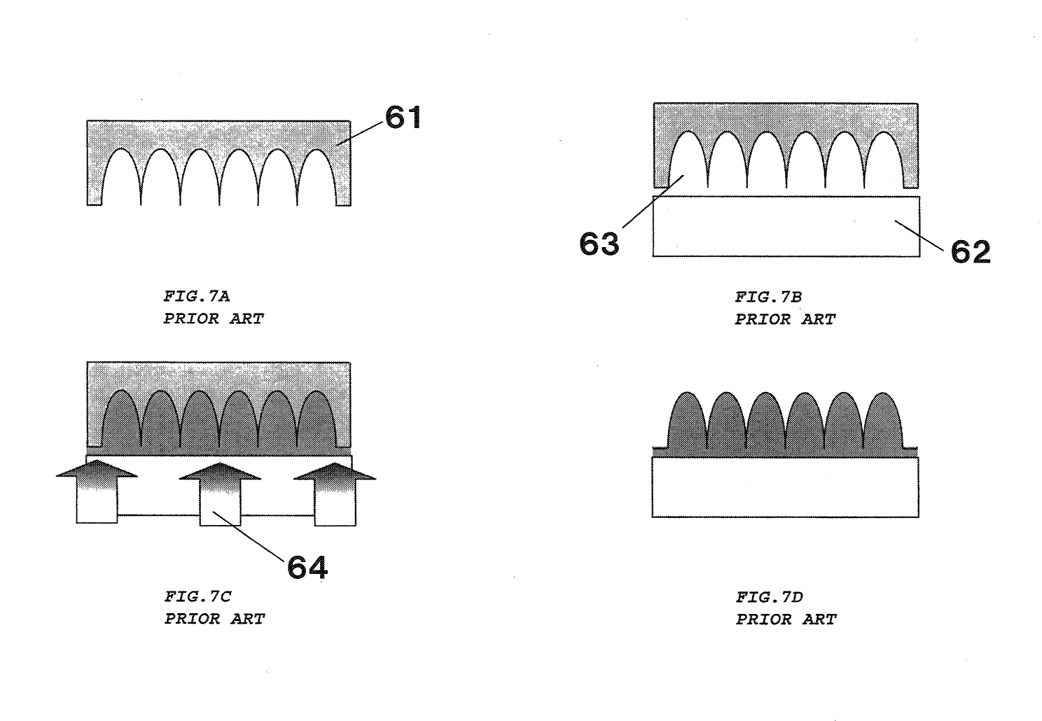

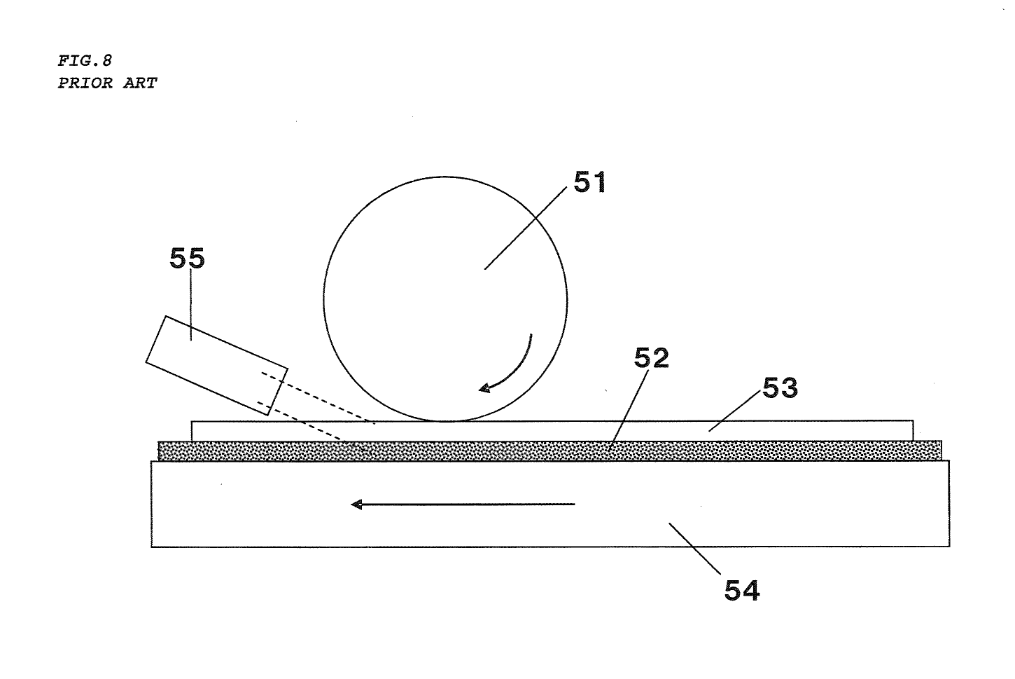

Moreover, in the aforesaid embodiment, with the one end part (the end part on the left side in FIG. 1) being fixed by the mold fixing jig 12 that has been installed on the supporting stand 19, the other end part (the end part on the right side in FIG. 1) has been lifted by the angle adjusting roll 13 concerning the surface of the UV hardening resin 17, and fixed to the tension jig 14 while maintaining the constant angle θ. However, for example, as is shown in FIG. 6, the one end part (the end part on the left side in FIG. 6) may also be lifted by the second angle adjusting roll 113 concerning the surface of the UV hardening resin 17, and fixed to the second tension jig 114 while maintaining the constant angle 0. By this configuration, since releasing is serially performed after the UV hardening resin hardens by the UV irradiation, it is not necessary to allow the first pressing roll 15 to move in the reverse direction, as mentioned in the aforesaid embodiment, to do the releasing. FIG. 6 is a schematic drawing that shows the configuration of a variant example of the device in the embodiment of the present invention for forming fine patterns, and the elements that are the same as those of the aforesaid embodiment are denoted with the same symbols.

A method and a device of the present invention for forming fine patterns can realize, for example, in a UV-hardening-technique roller nano-imprint using a UV hardening resin, transcription of high precision, and are useful for a use of a method and a device for forming fine patterns using a nano-imprint technology.

What is claimed is:

1. A method for forming fine patterns, comprising:
holding, by a holding member, a sheet-like deformable thin-plate mold with fine patterns having been predeterminedly formed, above a UV-light-transparent substrate such that a UV hardening resin has been applied beforehand on a surface thereof, in such a manner that the mold is at a predetermined angle inclined with tension being applied;
letting a surface of the thin-plate mold serially get in contact with the UV hardening resin by allowing, after a first pressing roll installed above the thin-plate mold is allowed to descend from above the thin-plate mold, the first pressing roll to relatively move concerning the substrate in a lateral direction while pressing, by the first pressing roll, the thin-plate mold against the UV hardening resin with a predetermined pressure;
letting the UV hardening resin, which has been applied onto the substrate, harden by irradiating, with UV light from below the substrate, a contact part of the thin-plate mold and the UV hardening resin; and
allowing the thin-plate mold to get released from the substrate.

2. A method for forming fine patterns according to claim 1, wherein
the thin-plate mold is being held, by the holding member, above the substrate so as to be at the predetermined angle inclined with the tension being applied, in such a state that one end of the thin-plate mold is connected to a supporting stand that supports the substrate.

3. A method for forming fine patterns according to claim 1, wherein
when the thin-plate mold is allowed to get released from the substrate, the thin-plate mold is, by allowing the first pressing roll to relatively move in a direction reverse to the lateral direction, allowed to serially get released from the substrate.

4. A method for forming fine patterns according to claim 1, wherein
when the first pressing roll is allowed to relatively move concerning the substrate, the angle between the thin-plate mold and the surface of the substrate is kept constant by allowing the holding member, which holds the thin-plate mold, to move in a vertical direction in synchronization with movement of the first pressing roll.

5. A method for forming fine patterns according to claim 1, wherein
after a second pressing roll, which has been, above the thin-plate mold, installed on an opposite side of the holding member with reference to a position of the first pressing roll, is allowed to descend in synchronization with descent of the first pressing roll, the thin-plate mold is pressed by the second pressing roll with a predetermined pressure.

6. A method for forming fine patterns according to claim 5, wherein
the UV hardening resin, which is between the first pressing roll and the second pressing roll, is irradiated with the UV light.

7. A method for forming fine patterns according to claim 1, wherein
when irradiation with the UV light is carried out from below the substrate, the irradiation with the UV light is carried out via a light-shielding mask that is installed below the substrate.

8. A method for forming fine patterns according to claim 1, wherein
when the substrate is irradiated with the UV light, irradiation is carried out while a UV light source used for the irradiation is allowed to vibrate in a substrate width direction vertical to a relative movement direction of the first pressing roll.

9. A method for forming fine patterns according to claim 7, wherein
as the UV light source, a light source is used such that a spread angle is collimated so as to be equal to or less than 5 degrees.

10. A method for forming fine patterns according to claim 7, wherein
a spacer that has a constant thickness, or a film that has fine protrusions is inserted between the substrate and the light-shielding mask, and between the light-shielding mask and a supporting stand that supports the substrate.

11. A device for forming fine patterns, comprising:
a UV-light-transparent substrate such that a UV hardening resin has been applied beforehand on a surface thereof;
a supporting stand that supports the substrate;
a sheet-like deformable thin-plate mold with fine patterns having been predeterminedly formed, which is arranged on the substrate;
a first pressing roll, which is arranged above the thin-plate mold and is able to ascend and descend with reference to the substrate; and
a UV light source that is installed below the substrate, wherein
the supporting stand is, along with the thin-plate mold, relatively movable concerning the first pressing roll in a lateral direction, and
when the first pressing roll presses the thin-plate mold, at least one end side of the thin-plate mold is, by the holding member, lifted concerning the UV hardening resin.

12. A device for forming fine patterns according to claim 11, wherein
at a predetermined position on another end side of the thin-plate mold, the thin-plate mold is being pressed against the UV hardening resin by a second pressing roll, and
the UV hardening resin, which is between the first pressing roll and the second pressing roll, is irradiated with UV light from the UV light source.
